(19) United States
(12) Patent Application Publication
(10) Pub. No.: US 2023/0327268 A1
(43) Pub. Date: Oct. 12, 2023

(54) MULTI-PIECE ENCLOSURE COVERS FOR TRACTION BATTERY PACKS WITH CELL-TO-PACK BATTERY SYSTEMS

(71) Applicant: FORD GLOBAL TECHNOLOGIES, LLC, Dearborn, MI (US)

(72) Inventors: Patrick Daniel MAGUIRE, Ann Arbor, MI (US); Jason C. MARCATH, Dearborn, MI (US); Karen SILER, Commerce Township, MI (US)

(21) Appl. No.: 17/893,327

(22) Filed: Aug. 23, 2022

Related U.S. Application Data
(60) Provisional application No. 63/322,766, filed on Mar. 23, 2022.

(51) Int. Cl. H01M 50/271; H01M 50/249; B60L 50/64; H01M 50/204

(52) U.S. Cl. CPC H01M 50/271; B60L 50/64; H01M 50/204; H01M 50/249; H01M 2220/20

(57) ABSTRACT

Multi-piece enclosure covers are disclosed for use on traction battery packs that include cell-to-pack battery systems. An exemplary multi-piece enclosure cover may include a plurality of individually removable cover panels. The cover panels may be positioned in a shingled or overlapping fashion relative to one another for covering the cell-to-pack battery system. Each cover panel may be individually removed relative to the remaining cover panels of the enclosure cover for servicing one or more battery internal components of the traction battery pack. The unremoved cover panels may support a portion of the tensile loads acting upon an enclosure tray of the traction battery pack while another cover panel is removed.

### CROSS-REFERENCE TO RELATED APPLICATIONS

This disclosure claims priority to United States Provisional Application No. 63/322,766, which was filed on Mar. 23, 2022 and is incorporated herein by reference.

### TECHNICAL FIELD

This disclosure relates generally to traction battery packs, and more particularly to multi-piece enclosure covers for traction battery packs that include cell-to-pack battery systems.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack can power the electric machines and other electrical loads of the vehicle.

Conventional traction battery packs include groupings of battery cells called battery arrays. The battery arrays include various array support structures (e.g., array frames, spacers, rails, walls, end plates, bindings, etc.) that are arranged for grouping and supporting the battery cells in multiple individual units inside the traction battery pack enclosure.

### SUMMARY

A traction battery pack according to an exemplary aspect of the present disclosure includes, among other things, an enclosure assembly including an enclosure cover and an enclosure tray, and a battery system housed within the enclosure assembly. The enclosure cover includes a multi-piece design having a plurality of individually removable cover panels.

In a further non-limiting embodiment of the foregoing traction battery pack, a cell row separator is positioned between a first cell stack and a second cell stack of the battery system.

In a further non-limiting embodiment of either of the foregoing traction battery packs, the battery system is a cell-to-pack battery system. The enclosure tray provides a cell-compressing opening for compressing a cell matrix of the cell-to-pack battery system.

In a further non-limiting embodiment of any of the foregoing traction battery packs, at least one of the plurality of individually removable cover panels includes a protruding section for accommodating a second tier component of the traction battery pack.

In a further non-limiting embodiment of any of the foregoing traction battery packs, a first cover panel of the plurality of individually removable cover panels includes a first sealing flange that is arranged to overlap a second sealing flange of a second cover panel of the plurality of individually removable cover panels.

In a further non-limiting embodiment of any of the foregoing traction battery packs, a seal is disposed between the first sealing flange and the second sealing flange for sealing a seam of the enclosure cover.

In a further non-limiting embodiment of any of the foregoing traction battery packs, the plurality of individually removable cover panels are secured to a cover skeleton of the enclosure cover.

In a further non-limiting embodiment of any of the foregoing traction battery packs, the enclosure skeleton includes a perimeter portion that is secured to the enclosure tray.

In a further non-limiting embodiment of any of the foregoing traction battery packs, the enclosure skeleton includes a plurality of supporting ribs that extend to a height above the perimeter portion to establish a domed area above the battery system.

In a further non-limiting embodiment of any of the foregoing traction battery packs, each of the plurality of individually removable cover panels are removably secured to at least two of the supporting ribs.

In a further non-limiting embodiment of any of the foregoing traction battery packs, each remaining cover panel of the plurality of individually removable cover panels is configured to function as a tensile member for distributing a tensile load acting upon the enclosure tray when one or more cover panels of the plurality of individually removable cover panels is removed from the traction battery pack.

In a further non-limiting embodiment of any of the foregoing traction battery packs, each of the plurality of individually removable cover panels extends from a first side wall to a second side wall of the enclosure tray, the first side wall and the second side wall extending in parallel with a longitudinal centerline axis of the enclosure tray.

A method for servicing a traction battery pack according to another exemplary aspect of the present disclosure includes, among other things, removing a first cover panel from an enclosure cover to expose a battery internal component of the traction battery pack. The enclosure cover includes a plurality of individually removable cover panels. A remaining portion of the enclosure cover is configured to function as a tensile member for distributing a tensile load acting upon an enclosure tray of the traction battery pack after removing the first cover panel.

In a further non-limiting embodiment of the foregoing method, the traction battery pack includes a cell-to-pack battery system.

In a further non-limiting embodiment of either of the foregoing methods, the battery internal component is a battery cell.

In a further non-limiting embodiment of any of the foregoing methods, the remaining portion is a second cover panel of the plurality of individually removable cover panels.

In a further non-limiting embodiment of any of the foregoing methods, the remaining portion is a cover skeleton of the enclosure cover.

In a further non-limiting embodiment of any of the foregoing methods, the first cover panel is secured to the cover skeleton prior to removing the first cover panel.

In a further non-limiting embodiment of any of the foregoing methods, the method includes servicing the battery internal component after removing the first cover panel.

In a further non-limiting embodiment of any of the foregoing methods, the method includes re-attaching the first cover panel to the traction battery pack after servicing the battery internal component.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a traction battery pack of the electrified vehicle of FIG. 1.

FIG. 3 illustrates a cell-to-pack battery system of the traction battery pack of FIG. 2.

FIG. 4 is a partially exploded view of a traction battery pack having a cell-to-pack battery system.

FIG. 5 is a cross-sectional view through section 5-5 of FIG. 4 and illustrates a shingled or shiplaped configuration of a multi-piece enclosure cover.

FIG. 6 illustrates the multi-piece enclosure cover with one panel removed for servicing a battery internal component of the cell-to-pack battery system.

FIG. 7 illustrates another multi-piece enclosure cover with one panel removed for servicing a battery internal component of the cell-to-pack battery system.

FIG. 8 illustrates another exemplary multi-piece enclosure cover for a traction battery pack having a cell-to-pack battery system.

FIG. 9 illustrates a cover skeleton of the multi-piece enclosure cover of FIG. 8.

### DETAILED DESCRIPTION

This disclosure details multi-piece enclosure covers for traction battery packs that include cell-to-pack battery systems. An exemplary multi-piece enclosure cover may include a plurality of individually removable cover panels. The cover panels may be positioned in a shingled or overlapping fashion relative to one another for covering the cell-to-pack battery system. Each cover panel may be individually removed relative to the remaining cover panels of the enclosure cover for servicing one or more battery internal components of the traction battery pack. The unremoved cover panels may support a portion of the tensile loads acting upon an enclosure tray of the traction battery pack while another cover panel is removed. These and other features are discussed in greater detail in the following paragraphs of this detailed description.

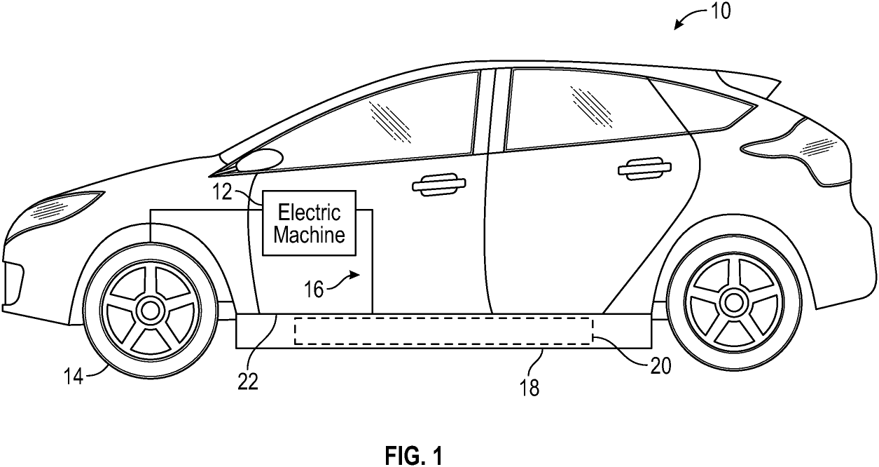

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV’s), fuel cell vehicles, etc. Therefore, although not specifically shown in the exemplary embodiment, the electrified vehicle 10 could be equipped with an internal combustion engine that can be employed either alone or in combination with other power sources to propel the electrified vehicle 10.

In an embodiment, the electrified vehicle 10 is a car. However, the electrified vehicle 10 could alternatively be a pickup truck, a van, a sport utility vehicle (SUV), or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more drive wheels 14 of the electrified vehicle 10.

A voltage bus 16 may electrically couple the electric machine 12 to a traction battery pack 18. The traction battery pack 18 is capable of outputting electrical power to power the electric machine 12 and/or other electrical loads of the electrified vehicle 10.

The traction battery pack 18 may be secured to an underbody 22 of the electrified vehicle 10. However, the traction battery pack 18 could be located elsewhere on the electrified vehicle 10 within the scope of this disclosure.

The traction battery pack 18 is an exemplary electrified vehicle battery. The traction battery pack 18 may be a high voltage traction battery pack that includes a cell-to-pack battery system 20. Unlike conventional traction battery pack battery systems, the cell-to-pack battery system 20 incorporates battery cells or other energy storage devices without the cells being arranged in individual arrays or modules. The cell-to-pack battery system 20 therefore eliminates most if not all the array support structures (e.g., array frames, spacers, rails, walls, end plates, bindings, etc.) necessary for grouping the battery cells into the arrays/modules. Further, the cell-to-pack battery system 20 may provide the total high voltage bus electrical potential of the traction battery pack 18 with a single battery unit as opposed to conventional battery systems that require multiple individual battery arrays/modules that must be connected together after being positioned within the battery enclosure for achieving the total high voltage electrical potential.

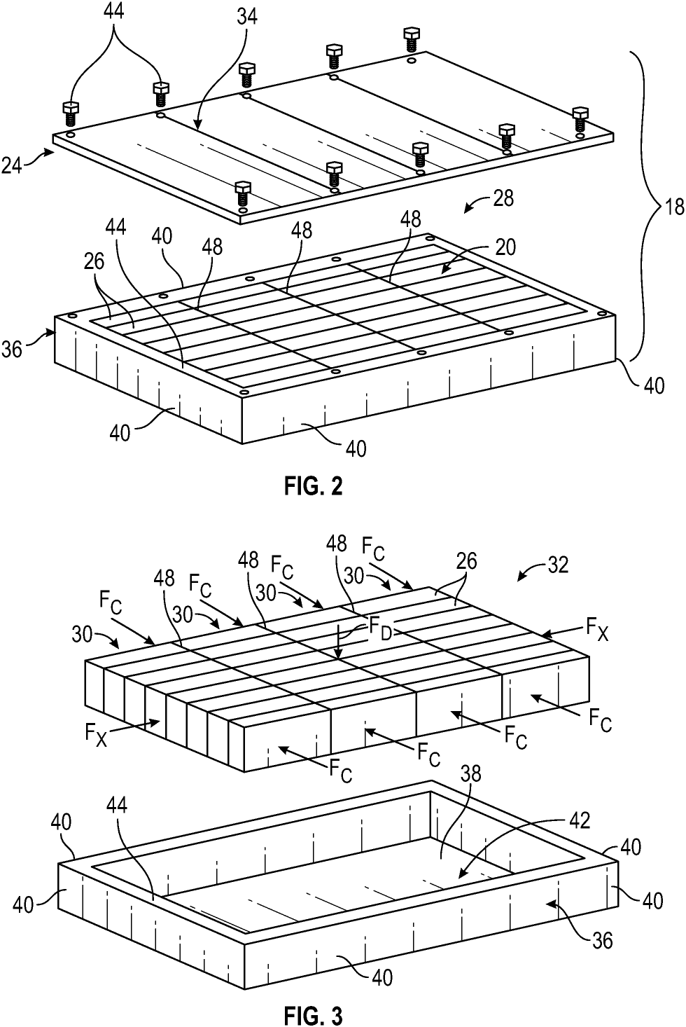

Referring now to FIGS. 2 and 3, the traction battery pack 18 may include an enclosure assembly 24 that is arranged for housing the cell-to-pack battery system 20. In an embodiment, the cell-to-pack battery system 20 includes a plurality of battery cells 26 that are held within an interior area 28 established by the enclosure assembly 24.

The battery cells 26 may supply electrical power to various components of the electrified vehicle 10. The battery cells 26 may be stacked side-by-side relative to one another to construct a cell stack 30, and the cell stacks 30 may be positioned side-by-side in rows to provide a cell matrix 32.

In an embodiment, each cell stack 30 includes eight individual battery cells 26, and the cell matrix 32 includes four cell stacks 30 for a total of thirty-two battery cells 26. Providing an even quantity of battery cells 26 and an even quantity of cell stacks 30 can help to support an efficient electrical bussing arrangement. Although a specific number of battery cells 26 and cells stacks 30 are illustrated in the various figures of this disclosure, the cell-to-pack battery system 20 of the traction battery pack 18 could include any number of battery cells 26 and any number of cell stacks 30. In other words, this disclosure is not limited to the exemplary configuration shown in FIGS. 2 and 3.

In an embodiment, the battery cells 26 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

The enclosure assembly 24 of the traction battery pack 18 may include an enclosure cover 34 and an enclosure tray 36. The enclosure cover 34 may be secured to the enclosure tray 36 to provide the interior area 28 for housing the cell-to-pack battery system 20.

The enclosure tray 36 may include a floor 38 and a plurality of side walls 40 arranged relative to one another to provide a cell-compressing opening 42. The floor 38 and the side walls 40 may be mechanically coupled to one another, such as by welding, for example.

During assembly of the traction battery pack 18, the enclosure cover 34 may be secured to the enclosure tray 36 at an interface 44 that substantially circumscribes the interior area 28. In some implementations, mechanical fasteners 46 may be used to secure the enclosure cover 34 to the enclosure tray 36, although other fastening methodologies (adhesion, etc.) could also be suitable.

The cell matrix 32 of the cell-to-pack battery system 20 may be positioned within the cell-compressing opening 42 provided by the enclosure tray 36. The exemplary enclosure tray 36 is depicted as including a single cell-compressing opening 42, however it should be understood that this disclosure extends to structural assemblies that provide one or more cell-compressing openings. The enclosure cover 34 may cover the cell matrix 32 within the cell-compressing opening 42 to substantially surround the battery cells 26 on all sides. Once fully assembled and positioned relative to the enclosure tray 36, the cell matrix 32 may establish a single battery unit capable of providing the total high voltage bus electrical potential of the traction battery pack 18.

The enclosure tray 36 may compress and hold the cell matrix 32 when the cell matrix 32 is received within the cell-compressing opening 42. In an embodiment, the side walls 40 of the enclosure tray 36 apply forces to the cell matrix 32 when the cell matrix 32 is positioned within the cell-compressing opening 42.

In an embodiment, in order to insert the cell matrix 32 into the cell-compressing opening 42, the cell matrix 32 may first be compressed, and then, while compressed, moved into place in the cell-compressing opening 42. A compressive force F_{C} may be applied to opposed ends of one of the cell stacks 30. The compressive force F_{C} essentially squeezes the battery cells 26 within the cell stack 30, thereby compressing the cell stack 30 and the individual battery cells 26 to a reduced thickness. While the compressive force F_{C} is applied to the cell stack 30, the cell stack 30 may be inserted into a respective cell-compressing opening 42 by a downward force F_{D}. The downward force F_{D} may be applied directly to one or more of the battery cells 26.

While the term “downward” is used herein to describe the downward force F_{D}, it should be understood that the term “downward” is used herein to refer to all forces tending to press a cell stack 30 into a cell compressing opening 42. In particular, the term “downward” refers to all forces substantially perpendicular to the compressive force F_{C}, whether or not the force is truly in a “downward” direction. For example, this disclosure extends to cell stacks that are compressed and inserted into a cell-compressing opening in a sideways direction.

The cell stacks 30 could be individually compressed and inserted into the cell-compressing opening 42. In another embodiment, the entire cell matrix 32 is compressed and inserted into the cell-compressing opening 42. As schematically shown in FIG. 3, in such an embodiment, additional compressive forces Fx can compress the cell stacks 30 together for insertion of the cell matrix 32 into the cell-compressing opening 42. The compressive forces F_{X} are generally perpendicular to the compressive forces F_{C}. The compressive forces Fx may be applied together with the compressive forces F_{C}. The force F_{D} may then be applied to move the entire cell matrix 32 into the cell-compressing opening 42.

In an embodiment, an entire perimeter of the cell-compressing opening 42 is defined by the side walls 40 of the enclosure tray 36. The side walls 40 can apply a compressive force to the battery cells 26 about the entire perimeter of the cell matrix 32. The side walls 40 may therefore function as a rigid halo-type structure that compresses and tightly holds the cell matrix 32.

The configuration described above is considered to be a cell-to-pack type battery pack, which differs from conventional battery pack types that include enclosures holding arrays of battery cells enclosed by array support structures that are spaced apart from walls of a battery enclosure, and where the battery enclosure does not apply compressive forces to any of the battery cells. The cell-to-pack type battery pack described herein also eliminates the rigid cross members that are commonly secured to the enclosure tray of conventional traction battery backs for providing mounting points for securing the battery arrays and the enclosure cover.

The cell-to-pack battery system 20 may further include one or more cell row separators 48. In an embodiment, one cell row separator 48 is positioned between each adjacent pair of cell stacks 30 of the cell matrix 32. In other embodiments, two cell row separators 48 are provided with each cell stack 30. However, the total number of cell row separators 48 provided within the cell-to-pack battery system 20 is not intended to limit this disclosure. The cell row separators 48 may provide various functions and advantages to the cell-to-pack battery system 20, including but not limited to maintaining battery cells 26 of adjacent cell stacks 30 spaced apart from one another, adding stiffness across the cell matrix 32 to prevent drooping and/or buckling, providing mounting points for securing the enclosure cover 34 directly to the cell-to-pack battery system 20, etc. The functionality provided by the cell row separators 48 may be particularly beneficial for traction battery packs that include cell-to-pack type battery systems because the array support structures traditionally provided within battery arrays has been largely eliminated from the cell-to-pack battery system 20.

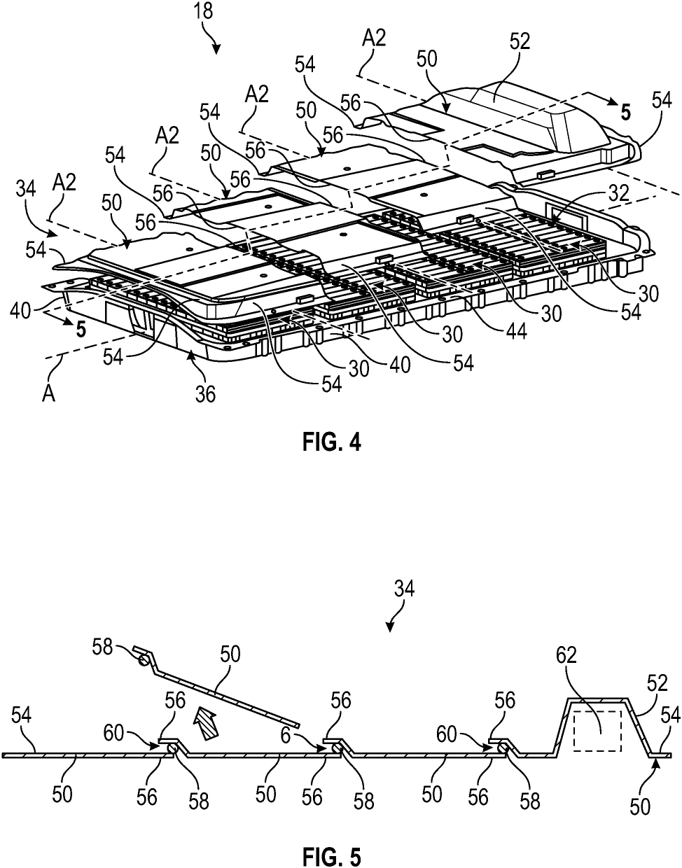

FIGS. 4-5, with continued reference to FIGS. 1-3, illustrate an exemplary design of an enclosure cover 34 of the traction battery pack 18. In an embodiment, the enclosure cover 34 embodies a multi-piece design that includes a plurality of cover panels 50. In the illustrated embodiment, the enclosure cover 34 includes a total of four cover panels 50. However, a greater or fewer number of cover panels 50 could be provided as part of the enclosure cover 34 within the scope of this disclosure.

The cover panels 50 of the enclosure cover 34 may be metallic-based components, polymer-based components, or mixed-material components that include both metals and polymers. The exact material make-up of each cover panel 50 is not intended to limit this disclosure.

Each cover panel 50 may be arranged to extend between opposing side walls 40 of the enclosure tray 36 for covering the cell matrix 32 and other battery internal components of the traction battery pack 18. In an embodiment, each cover panel 50 extends along a respective longitudinal axis A2 that is transverse to a central longitudinal axis A of the enclosure tray 36, and the longitudinal axes A2 may extend in a cross-vehicle direction when the traction battery pack 18 is mounted on the electrified vehicle 10. However, other configurations are also contemplated.

One or more of the cover panels 50 may be configured differently from the other cover panels 50 of the enclosure cover 34. The cover panels 50 can be configured differently in terms of size, shape, features, etc. For example, one of the cover panels 50 may include a protruding section 52 for accommodating a second tier component 62 (see FIG. 5) of the traction battery pack 18.

Each cover panel 50 may include one or more mounting flanges 54 and one or more sealing flanges 56. The mounting flanges 54 may be received relative to the interface 44 of the enclosure tray 36 for securing the cover panel 50 to the enclosure tray 36. The sealing flanges 56 may interface with a sealing flange 56 of a neighboring cover panel 50 of the enclosure cover 34. In an embodiment, the neighboring sealing flanges 56 may overlap with one another to provide a “shingled” or “shiplaped” configuration. A seal 58 may be positioned between the sealing flanges 56 of neighboring cover panels 50 for sealing a seam 60 therebetween (see FIG. 5).

In an embodiment, the sealing flanges 56 are provided on longitudinal sides of the cover panel 50 and thus extend in parallel with the longitudinal axis A2, and the mounting flanges 54 are provided on transverse sides of the cover panel 50 and thus extend transverse to the longitudinal axes A2. However, in some configurations, some of the mounting flanges 54 may also be provided on a longitudinal side of the cover panel 50, such as for cover panels 50 positioned at the ends of the enclosure cover 34, for example.

Each cover panel 50 may be individually removed from the enclosure cover 34 for servicing a battery internal component (e.g., a battery cell 26 of one of the cell stacks 30) of the traction battery pack 18. Each cover panel 50 may therefore be removed without removing the remaining cover panels 50 of the enclosure cover 34 in order to service any component housed inside the enclosure assembly 24. The battery servicing procedure may include repairing or replacing a battery cell 26, for example. The cover panel 50 may be re-attached to the remaining cover panels 50 of the enclosure cover 34 after performing the battery servicing procedure.

In the illustrated embodiment of FIG. 5, the second cover panel 50 from the left is shown being removed during a battery servicing procedure. However, it should be understood that any cover panel 50 of the enclosure cover 34 could be removed. Moreover, multiple cover panels 50 could be removed during the battery servicing procedure to the extent necessary.

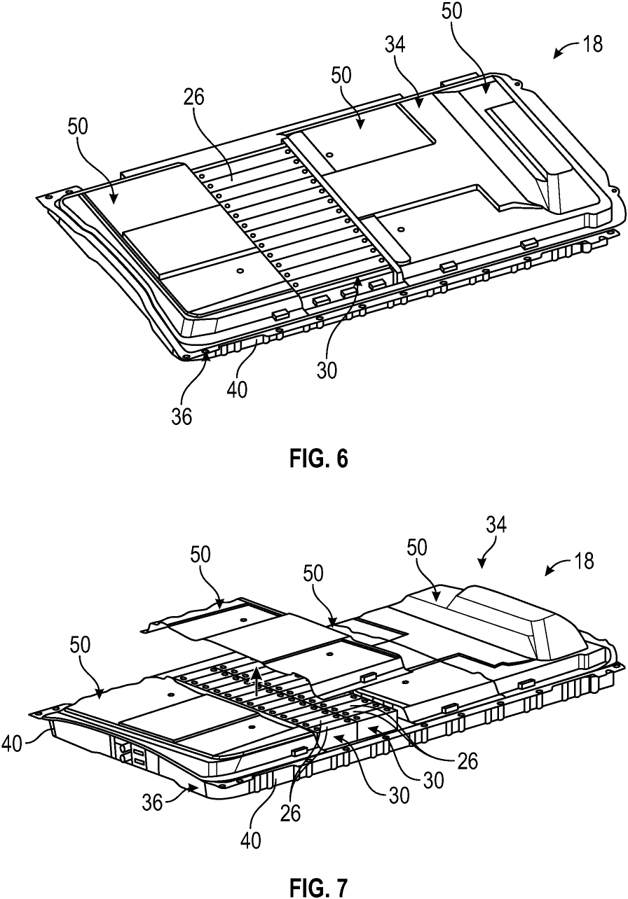

In embodiment, the cover panel 50 that is removed may expose/reveal a single cell stack 30 (see FIG. 6). In another embodiment, the cover panel 50 that is removed may expose/reveal multiple cell stacks 30 (see FIG. 7). Each cover panel 50 may therefore be sized as appropriate for any given design.

When one or more of the cover panels 50 are removed, the remaining cover panels 50 of the enclosure cover 34 may carry a portion of tensile loads acting on the enclosure tray 36, such as from the cell matrix 32. The tensile loads may be the result of expansive or “swelling” forces being applied by the battery cells 26 of the cell matrix 32. Tension through the cover panels 50 that remain secured in place may substantially prevent the side walls 40 of the enclosure tray 36 from bowing or otherwise distorting under the forces generated by the tensile loads.

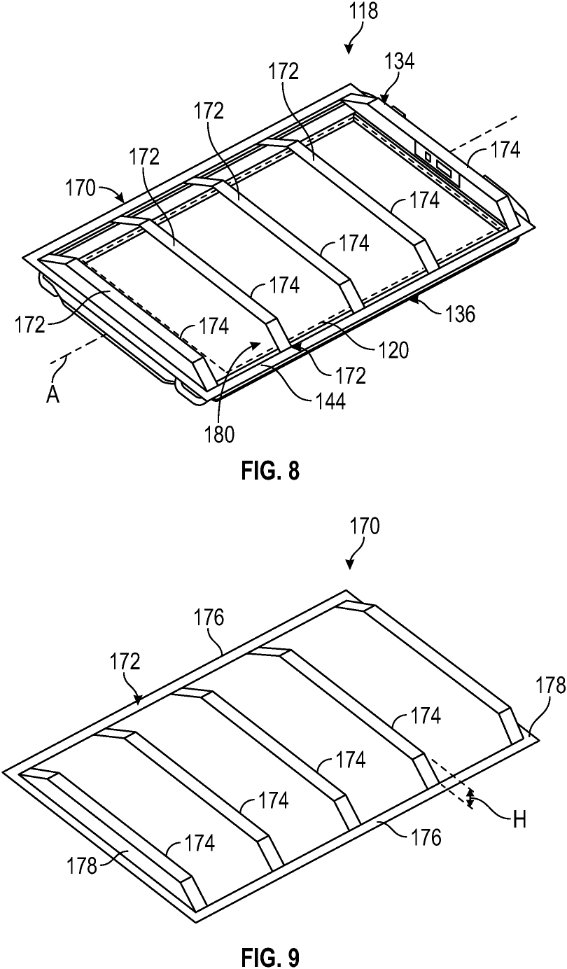

FIG. 8 illustrates another exemplary enclosure cover 134 for a traction battery pack 118. The enclosure cover 134 may embody a multi-piece design that includes a cover skeleton 170 and a plurality of cover panels 150. The enclosure cover 134 may be secured to an enclosure tray 136 for housing a cell-to-pack battery system 120 inside the traction battery pack 118.

Referring now to FIGS. 8 and 9, the cover skeleton 170 may include a perimeter portion 172 and a plurality of supporting ribs 174 connected to the perimeter portion 172. The perimeter portion 172 may be rectangular-shaped and may include longitudinal rails 176 and transverse rails 178 that connect between the longitudinal rails 176. In an embodiment, the longitudinal rails 176 extend in parallel with a longitudinal centerline axis A of the enclosure tray 136. The perimeter portion 172 may be received against an interface 144 of the enclosure tray 136 for securing the cover skeleton 170 to the enclosure tray 136.

The supporting ribs 174 may be connected to and extend between the longitudinal rails 176 of the perimeter portion 172. Each supporting rib 174 may be arched-shaped (e.g., pseudo three-center arched shaped). By virtue of the arched-shape, the supporting ribs 174 may extend to a height H above the perimeter portion 172 to establish a domed area 180 above the cell-to-pack battery system 120. In another embodiment, the supporting ribs 174 may be flat rather than arched.

The supporting ribs 174 may establish mounting points for securing the cover panels 150 to the cover skeleton 170. The cover panels 150 may be removably secured to the supporting ribs 174 using any type of fixation technique.

Each cover panel 150 may be individually removed from the cover skeleton 170 for servicing a battery internal component (e.g., any component of the cell-to-pack battery system 120) of the traction battery pack 118. Each cover panel 150 may therefore be removed without removing the remaining cover panels 150 of the enclosure cover 134. The cover skeleton 170, and in particular the supporting ribs 174, may establish a tensile load path for distributing tensile loads that may act upon the enclosure tray 136 even when one or more of the cover panels 150 are removed.

The exemplary multi-piece enclosure covers of this disclosure provide for servicing the traction battery pack without losing enclosure tray structure. The multi-piece design allows portions of the cover to stay intact and continue to provide tensile load support during battery servicing procedures. The enclosure cover may therefore be easier to reassemble to the tray after the battery servicing procedures have been completed.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly including an enclosure cover and an enclosure tray;
a battery system housed within the enclosure assembly; and
the enclosure cover including a multi-piece design having a plurality of individually removable cover panels.

2. The traction battery pack as recited in claim 1, comprising a cell row separator positioned between a first cell stack and a second cell stack of the battery system.

3. The traction battery pack as recited in claim 1, wherein the battery system is a cell-to-pack battery system, and further wherein the enclosure tray provides a cell-compressing opening for compressing a cell matrix of the cell-to-pack battery system.

4. The traction battery pack as recited in claim 1, wherein at least one of the plurality of individually removable cover panels includes a protruding section for accommodating a second tier component of the traction battery pack.

5. The traction battery pack as recited in claim 1, wherein a first cover panel of the plurality of individually removable cover panels includes a first sealing flange that is arranged to overlap a second sealing flange of a second cover panel of the plurality of individually removable cover panels.

6. The traction battery pack as recited in claim 5, comprising a seal disposed between the first sealing flange and the second sealing flange for sealing a seam of the enclosure cover.

7. The traction battery pack as recited in claim 1, wherein the plurality of individually removable cover panels are secured to a cover skeleton of the enclosure cover.

8. The traction battery pack as recited in claim 7, wherein the enclosure skeleton includes a perimeter portion that is secured to the enclosure tray.

9. The traction battery pack as recited in claim 8, wherein the enclosure skeleton includes a plurality of supporting ribs that extend to a height above the perimeter portion to establish a domed area above the battery system.

10. The traction battery pack as recited in claim 9, wherein each of the plurality of individually removable cover panels are removably secured to at least two of the supporting ribs.

11. The traction battery pack as recited in claim 1, wherein each remaining cover panel of the plurality of individually removable cover panels is configured to function as a tensile member for distributing a tensile load acting upon the enclosure tray when one or more cover panels of the plurality of individually removable cover panels is removed from the traction battery pack.

12. The traction battery pack as recited in claim 1, wherein each of the plurality of individually removable cover panels extends from a first side wall to a second side wall of the enclosure tray, the first side wall and the second side wall extending in parallel with a longitudinal centerline axis of the enclosure tray.

13. A method for servicing a traction battery pack, comprising:
removing a first cover panel from an enclosure cover to expose a battery internal component of the traction battery pack,
wherein the enclosure cover includes a plurality of individually removable cover panels, and
wherein a remaining portion of the enclosure cover is configured to function as a tensile member for distributing a tensile load acting upon an enclosure tray of the traction battery pack after removing the first cover panel.

14. The method as recited in claim 13, wherein the traction battery pack includes a cell-to-pack battery system.

15. The method as recited in claim 13, wherein the battery internal component is a battery cell.

16. The method as recited in claim 13, wherein the remaining portion is a second cover panel of the plurality of individually removable cover panels.

17. The method as recited in claim 13, wherein the remaining portion is a cover skeleton of the enclosure cover.

18. The method as recited in claim 17, wherein the first cover panel is secured to the cover skeleton prior to removing the first cover panel.

19. The method as recited in claim 13, comprising servicing the battery internal component after removing the first cover panel.

20. The method as recited in claim 19, comprising re-attaching the first cover panel to the traction battery pack after servicing the battery internal component.
